(19) United States
(12) Patent Application Publication
(10) Pub. No.: US 2008/0047939 A1
(43) Pub. Date: Feb. 28, 2008

(54) PROCESS AND APPARATUS FOR JOINING AT LEAST TWO ELEMENTS

(76) Inventor: Stefan Hummelt, Darmstadt (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/839,686

(22) Filed: Aug. 16, 2007

Related U.S. Application Data
(63) Continuation-in-part of application No. 11/828,377, filed on Jul. 26, 2007, now abandoned.
(60) Provisional application No. 60/840,199, filed on Aug. 25, 2006.

(51) Int. Cl. B23K 26/20

(52) U.S. Cl. 219/121.64; 219/121.63

(57) ABSTRACT

Process and apparatus for joining at least two elements, in particular an electronic component such as an LED with a substrate, such as a PCB. An imaging means divides a light beam into a plurality of partial light beams and images these partial light beams, forming a plurality of discrete light spots, which form a plurality of discrete material joining portions. The light beam is divided using a diffractive optical element (DOE) also enabling a beam shaping and beam processing. A plurality of material joining portions can be formed simultaneously enabling a high process rate. The method is suited for laser soldering of components, which are not exposed to high thermal loads, e.g. for forming electrical contacting portions of LEDs. These discrete light spots can also be used for material processing, in particular for simultaneously forming a plurality of preweakened material zones or perforations in a substrate.

### RELATED APPLICATIONS

The present application is a continuation-in-part of and claims priority under 35 U.S.C. §120 to U.S. application Ser. No. 11/828,377, filed on Jul. 26, 2007, which is in turn related to and claims benefit under 35 U.S.C. § 119(e) to U.S. Provisional Application No. 60/840,199, filed on Aug. 25, 2006, both of which are entitled “Process and Apparatus for Joining at Least Two Elements”, the whole content of both of which are hereby incorporated by reference.

### FIELD OF THE INVENTION

The present invention relates in general to joining or connecting of two elements, in particular by means of a material joining, most preferably using soft-soldering, and relates in particular to a method for contacting of electronic or micro-electronic components using soft-soldering. A related further aspect of the present invention generally relates to a method for processing a substrate using laser beams, in particular for processing web-like or sheet-like materials of arbitrary materials, preferably of plastics, metal sheet, paper, cardboard or fabrics, in particular for forming preweakened zones or perforations in such substrates or materials using laser beams.

### BACKGROUND OF THE INVENTION

In the assembly of electronic devices nowadays, it is necessary to solder 40,000 components or even more components per hour. Therefore, in the mass production of electronic devices, in particular for the mass production of printed circuit boards (PCB) including components, primarily so-called reflow soldering or remelting soldering is used. Reflow soldering is a method for soft-soldering of SMD (surface mounted devices) components. In a first step during soft-soldering the soft solder is applied before positioning the components on the surface of the printed circuit board. In a next step, the components are positioned. As the soldering paste used is adhesive, the components are held directly by the soldering paste during positioning. Thus, it is not necessary to bond the components before soft soldering.

During the subsequent melting of the soldering agent, the components are centering automatically on the bonding pads due to the surface tension and settle themselves.

Although a high throughput can be achieved using reflow soldering, the components to be soldered encounter a high thermal load during reflow soldering. However, as the integration level and the functionality is ever increasing, micro-electronic components become more and more temperature-sensitive. This holds in particular for micro-electromechanical systems (MEMS). Furthermore, it is necessary to take into account that the European Community Directive on Waste Electrical and Electronic Equipment (WEEE) enters into force on Jul. 1, 2006, which necessitates a change-over to lead-free electronic products. However, lead-free soldering, which is prescribed in the future by WEEE, usually causes higher soldering temperatures, which can easily be higher by about 20 K, which further increases the thermal load during soldering. Accordingly, there exists a need for soldering methods in the production of electronic devices which enables a reduction of the thermal load.

In order to obtain a higher tensile strength of solderings, one usually prefers solders having a higher content of antimony. Due to the higher melting temperature of antimony (Sb), this causes higher soldering temperatures, which also increases the thermal load for components.

Other soldering methods, e.g. a wave-soldering process cannot solve the above problems.

Laser beam soldering is known in other technical fields. During laser beam soldering the soldering is heated using a laser beam, which can be focused with high precision and enables transferring a high amount of energy into the soldering. Thus, the soldering is heated with a very high spatial resolution, which enables short soldering periods of e.g. less than one second. Thus, an essentially vanishing thermal load for the components can be achieved.

German utility model DE 20 2004 013 136 U1 discloses a modular fiber cable optical unit for use for welding robotics for welding in the manufacturing of motor vehicles. The optical module is held by the hand of the robotics, which moves the light beam in an adequate geometry along the joining gap using linear motions and panning in order to form a welding seam.

U.S. patent application 2005/0082265 A1 discloses a laser welding process for producing a hydraulic pressure control device for a vehicle. In this method, a metal member and a resin member are welded or bonded to each other. In order to form the necessary closed welding seam, it is necessary to move the respective laser beam.

The use of robotics for deflecting beams causes relatively long welding or soldering times, which is not suitable in the mass production of electronic devices.

As an alternative galvanometer scanners can be used for deflecting a light beam, because galvanometer scanners are substantially free of inertia, which enables a higher deflecting speed as compared to motoric beam deflecting units. This enables in general the use of such galvanometer scanners in the production of electronic devices.

U.S. patent application 2004/0190294 A1 discloses a method for laser soldering of high power light-emitting diodes (LEDs). In this method, a plurality of solderings are formed along a curve, namely a circular curve. Deflection of the laser beam is accomplished using a scanner having two movable mirrors. The processing speed thus accomplished is, however, not sufficient for the production of electronic devices with high throughput, because such a soldering process is also carried out in a sequential manner and lasts for at least 0.5 sec. to about 2 sec. (not including the time required for transferring the substrate and the like). If one would increase the total number of scanners used in this method, this would require a very complex control of the scanners which would increase the production costs.

Comparable problems also occur in the processing of substrates, e.g. for forming a plurality of holes, blind holes and/or of preweakened zones in a pre-determined geometric configuration.

A conventional method for forming perforations in a substrate is disclosed in U.S. Pat. No. 4,568,815.

A plurality of perforations, which are disposed under uniform distances to each other, are formed in a web-like substrate, which passes a laser at uniform speed, using laser ablation or thermal melting. In order to determine the positions of the perforations, the laser beam is pulsed at high frequencies using a shutter and is deflected using a rotary scanner mirror. The mechanical inertia of the scanner mirror inherently limits the processing speed and increases the costs for maintenance.

Similar apparatuses, which use a scanner mirror for beam deflection for generating preweakened zones or perforations in materials, are disclosed in German utility model DE 200 13 469 U1 and German patent application DE 199 45 022 A1.

The processing speed is particularly limited by the inertia of the scanner mirrors, if preweakened zones or perforations are to be formed at locations on a substrate which are far away from each other. One approach for increasing the processing speed is the simultaneous use of plural laser beams, which are imaged using associated scanner mirrors and imaging optics. However, this further increases the processing costs.

### SUMMARY OF THE INVENTION

It is an object of the present invention to provide a process and an apparatus for joining at least two elements or components using light beams in order to easily accomplish a high processing or production speed and at the same time to reduce the thermal load for the elements of components to be joined. According to a particularly preferred application of the invention, electronic, opto-electronic or micro-electromechanical (MEMS) elements or components are to be soldered using laser light.

According to a related aspect of the present invention there is to be provided a process and apparatus for forming a plurality of preweakened material zones or perforations using light beams for accomplishing a high processing speed in an easy manner.

In a process according to the present invention, an imaging optics simultaneously divides the light beam, in particular a laser light beam, into a plurality of partial light beams, which are imaged onto the elements or components to be connected with each other, where these partial light beams form a plurality of discrete light spots. According to the invention, these light spots, due the transfer of a high amount of energy, cause the formation of a plurality of discrete material joining portions between the elements or components to be joined. Preferably, the elements or components are joined with each other at the joining portions by melting of a soft solder. However, the present invention is also suitable for hard-soldering, welding and also for photo-curing of an adhesive by means of the light spots.

Thus, according to the present invention, a plurality of material joinings or connections can be formed simultaneously, in particular solderings. According to the invention, a time consuming and costly deflection of a light beam is not necessary. As is well known, light beams can easily be divided into a plurality of partial light beams. As a certain minimum power per joining is necessary for forming a material joining between elements, in particular using soldering, the process according to the invention essentially only has the limit that the respective partial light beams must have a sufficient intensity or power. However, this can be accomplished in an essentially arbitrary manner by means of a suitable configuration of the beam dividing means and by a suitable choice of the light power of the input light beam.

According to the invention, the partial light beams are imaged and deflected directly before the imaging optics in order to form a plurality of joining simultaneously. The use of a diffractive optical element (DOE) associated to the imaging optics turned out to be of particular use in order to accomplish a suitable beam division, because this measure enables dividing high light intensities into partial light beams essentially without losses and with a suitable beam profile. More specifically, also an additional beam shaping effect can be accomplished using diffractive optical elements, in particular with regard to the beam cross section, the intensity, shape or beam profile and/or divergence of the respective partial light beams.

According to another embodiment, the joinings are disposed in a predetermined geometrical configuration. This might be caused e.g. by the configuration of the elements or components to be joined and/or by the geometrical configuration of these elements or components, e.g. on a holding means for positioning the elements or components to be joined while being processed. According to the invention, the diffractive optical element is configured such that the partial light beams are generated in accordance with this predetermined configuration of joinings and are directed and imaged into corresponding directions. It is of advantage that a further costly deflection of the partial light beams is not necessary. In order to accomplish an adjustment of the process to another geometrical configuration of the joinings, the diffractive optical element might be removable, e.g. held in a revolver unit or in another rotating or exchange unit.

Generally, a plurality of diffractive optical elements might be associated to the imaging optics. E.g. these plural diffractive optical elements might be held directly within the imaging optics in order to divide the input light beam into a plurality of partial light beams. However, according to another embodiment it is preferred to use a single diffractive optical element, which is traversed by the input partial light beam in its' entirety and comprises a plurality of diffractive optical zones or so-called active zones having a configuration which mates with the aforementioned predetermined configuration of the joinings. Thus, the diffractive optical element can comprise a single diffractive optical zone or a plurality of diffractive optical zones or active zones, which might be formed e.g. as alternating protruding and recessed zones of a linear, circular or elliptical form or as alternating portions, having different refractive indices or in another arbitrary manner as structures capable of diffracting light in a suitable manner. These active zones are preferably disposed on a single substrate, which is transparent to the input light beam, for which purpose this substrate can be held in a suitable manner, also removably in the beam path of the input light beam.

According to a preferred aspect of the present invention, each of the diffractive optical zones of the diffractive optical element is configured for imposing a suitable intensity, a suitable beam cross section, a suitable beam profile and/or beam divergence on the associated partial light beam. Thus, the individual diffractive optical zones can be configured in an arbitrary different manner.

Particularly, in this way also partial light beams having different intensities, can be accomplished in a simple manner so that material joinings, e.g. solderings, can be formed simultaneously by means of a different input of energy at different locations using a single input light beam.

According to another aspect of the present invention, the imaging optics comprises at least one input lens and an output lens apart to each other in the beam direction, so that a larger or smaller diameter of the laser beam can be adjusted by varying the distance between the input lens and the output lens. If a light waveguide, in particular an optical fiber, is used for coupling the input light beam into the imaging optics, also the distance between the input lens and the output side of the light waveguide can be varied, which enables additional degrees of freedom.

According to another aspect of the present invention, the diffractive optical element is disposed between the aforementioned input lens and the output lens, which makes an adjustment easier and reduces adjustment tolerances. At the same time, the diffractive optical element can be housed together with the input and output lens within a modular optics unit and in a sealed manner. The housing of the imaging optics might be configured in order to enable changing the diffractive optical elements for generating a different geometric configuration of the joinings, e.g. by means of a revolver unit or another rotating and changing unit, wherein several diffractive optical elements of different configurations are held.

A particularly preferred application of the process is related to soft-soldering of electronic or opto-electronic components, of micro-electromechanical elements (MEMS) or of connectors onto a carrier, e.g. a printed circuit board. In these applications, according to the present invention, a plurality of solderings can be generated simultaneously by suitably dividing a light beam, in particular a laser light beam, into a plurality of partial light beams, while said partial light beams are deflected and imaged in a suitable manner onto the solderings in accordance with the configuration of the elements or components and/or their geometrical configuration. According to the invention, a costly sequential deflection of a laser beam, using a scanner is not necessary. Thus, high processing speeds can be accomplished. At the same time the thermal load of the elements or components to be soldered is negligible. The diffractive optical element used might be configured so that a plurality of elements or components can be soldered at the same time. Thus, the process according to the present invention is also suitable for the production of electronic devices or components with high throughput. In such a process the partial light beams can be generated in particular with different intensities or power so that solderings of a different configuration can be generated at the same time, e.g. for contacting the elements or components as such, for contacting connectors or pull relieves for elements or connectors.

According to another related aspect of the present invention for forming a plurality of preweakened zones or perforations an imaging optics simultaneously divides a light beam, preferably a laser light beam, into a plurality of partial light beams using light diffraction, said partial light beams being imaged onto the substrate or material to be processed, where said partial light beams form a plurality of discrete light spots. As a result of the input of energy thus caused, according to the invention a plurality of discrete preweakened material zones or perforations are formed within the substrate or material, namely as a result of thermal melting or laser ablation of substrate material at the locations of the plural discrete light spots. The process according to this related aspect of the invention is in general suitable for the processing of arbitrary materials. Preferably, the process is applied to thin materials having a plane surface in the area to be processed. Preferably, the material should have a reflectivity as low as possible at the wavelength of the light source or laser beam in order to accomplish an optimum input of energy into the material.

Thus, according to the invention a plurality of preweakened material zones or perforations can be formed at the same time within the material to be processed. Therefore, a time consuming and costly beam deflection is not necessary according to the invention. It is well known that light beams can be divided easily into a plurality of partial light beams. As a certain minimum power per discrete light spot is required for forming preweakened material zones or perforations, the process according to the invention essentially is only limited in that the respective partial light beams still must have a sufficient intensity or power in order to process the material simultaneously at a plurality of discrete locations as desired. This can be accomplished in an essentially arbitrary manner by means of a suitable configuration of the beam divider and of a suitable selection of the beam power of the input light beam.

According to another embodiment the preweakened material zones or perforations are disposed in a predetermined geometric configuration, as required e.g. by the intended use of the substrate or material to be processed. If e.g. a circumventing line consisting of preweakened material zones is to be formed underneath the surface of a substrate, e.g. for forming a circumventing breaking line in a plastics material of an airbag cap, according to the invention it is preferred if all preweakened material zones of the circumventing line are formed at the same time within the substrate or material. According to the invention the diffractive optical element is formed and configured such that the partial light beams are (a) formed, (b) directed into respective directions and (c) imaged in accordance with this predetermined configuration of preweakened material zones or perforations. It is an advantage that an additional complex deflection of the partial light beams is not necessary anymore. In order to adjust the process to another geometric configuration of the preweakened material zones or perforations, the diffractive element optical element might be removable, e.g. held in a revolver unit or in another rotating or exchange unit.

The characteristics of the imaging optics can also govern certain parameters which are important for the processing of the material, e.g. the light intensity and beam profile. According to another embodiment the characteristics of the imaging optics are such that the preweakened material zones are formed underneath a surface of the substrate facing towards the imaging optics, i.e. deep under the surface of the material to be processed or even on the rear side of the substrate or material to be processed opposite to the imaging optics.

According to another embodiment the geometric shape of the preweakened zones or perforations is determined directly by the diffractive characteristics of the diffractive imaging optics, in particular of an associated diffractive zone of a diffractive optical element, in order to form the associated light spot forming the respective preweakened material zone or perforation. As an example, if the contour of a preweakened zone or perforation is shaped like an oblong hole, a partial light beam is divided and imaged by the diffractive imaging optics, in particular by an associated diffractive zone thereof, such that laser ablation or thermal melting of substrate material directly causes formation of a preweakened zone or perforation having a desired contour, without the necessity of an additional mechanical beam deflection and/or of a relative movement between substrate and laser beam.

### BRIEF SUMMARY OF THE DRAWINGS

In the following the invention will be set forth in an exemplary manner and with reference to the enclosed drawings, from which further features, advantages and problems to be solved can be derived, wherein:

FIG. 1 is a schematic view of an apparatus for laser soldering of electronic components according to the present invention;

FIG. 2 is an enlarged sectional view of an imaging optics of the apparatus according to FIG. 1;

FIG. 3 is a schematic partial cross section of a process for laser soldering of an LED according to the present invention;

FIG. 4 is a schematic plan view of the distribution of the solderings for electrically contacting a connector on a carrier, e.g. a printed circuit board;

FIG. 5 is a schematic view of an apparatus for according to a related aspect of the present invention for simultaneous forming of a plurality of preweakened material zones or perforations in a material of web form; and

FIG. 6 shows in a schematic plan view and in a partial view a substrate, which has been processed using the process according to the related aspect of the invention.

Throughout the drawings, the same reference numerals relate to identical or essentially equivalent elements or groups of elements.

### DETAILED DESCRIPTION OF EXEMPLARY EMBODIMENTS OF THE INVENTION

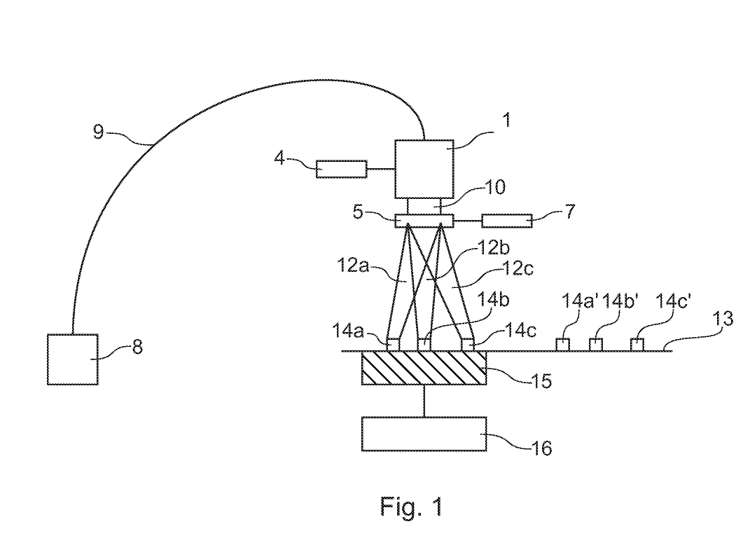

Referring to FIG. 1 the laser beam of a diode laser 8 is coupled into an optical fiber 9 and is directed towards an apparatus comprising a processing head supporting an imaging optics 1 with an associated diffractive optical element (DOE) 5. The input light beam 10 is divided into a plurality of partial light beams 12a-12c by the imaging optics 1. At the same time, these partial light beams 12a-12c are focused. The distance between the processing head and the printed circuit board (PCB) 13 is therefore adjusted in accordance with the focal length of the imaging optics 1 and the desired diameter of the beam spots on the printed circuit board 13. E.g. a distance between the processing head and the work piece to be processed of the order of about 10 cm to about 50 cm has been implemented. According to FIG. 1, a plurality of components (not shown) are disposed on the printed circuit board 13 in a periodic configuration, of which only respective three contact pins 14a, 14b, 14c for electrically contacting the components, are shown. The contact pins are positioned e.g. on soldering pads, bonding pads or the like of the printed circuit board 13 in a suitable geometric configuration, which might be determined e.g. by the layout of the circuit. The geometric configuration of the contact pins can be essentially arbitrary in the plane of printed circuit board 13. In order to accomplish a suitable imaging and deflection of the partial light beams 12a-12c only the imaging optics 1 and the diffractive optical element 5 need to be configured suitably, as set-forth below in more detail.

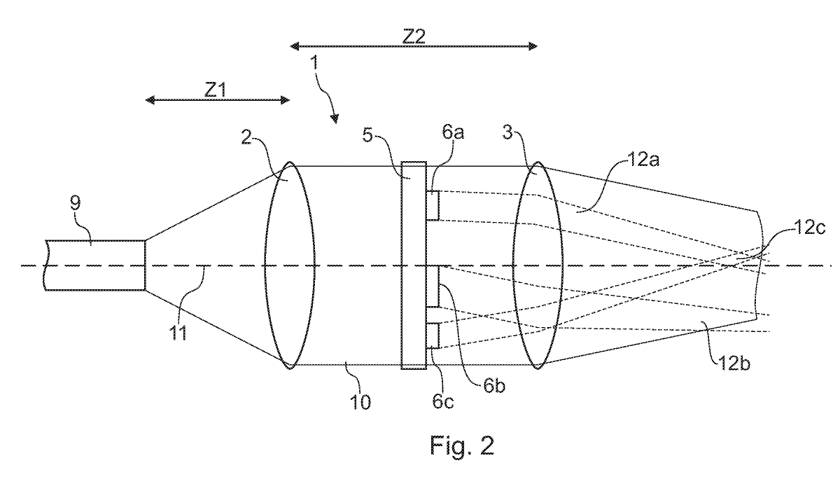

An adjustment device 4 can be provided for adjusting the imaging optics 1. As shown in FIG. 2, the adjustment device 4 can vary in particular the distance z1 between the input lens 2 of the imaging optics 1 and the output side of the optical fiber 9 and/or the distance z2 between the input lens 2 and the associated output lens 3 of the imaging optics 1, in order to adjust the diameter of the input light beam 10 and of the partial light beams 12a-12c as well as of the light spots in a suitable manner.

According to FIG. 1, the DOE 5 can be supported in a manual or motoric changing unit 7, e.g. a revolver unit or a comparable rotating unit. By actuating the changing unit 7, the DOE can be changed in order to set another suitable geometric configuration of the solderings.

According to FIG. 1, the printed circuit board 13 is supported on a translational device 15, e.g. a conveying belt or an x-/y-displacement table, wherein the translational unit 15 is driven by a drive 16.

In the process the components to be soldered onto the printed circuit board 13 are preferably positioned in a periodic, recurrent configuration. During a first process step, a plurality of solderings is generated in a first portion of the printed circuit board 13, e.g. the contact pins 14a-14c shown. These solderings might be disposed on a component. However, these solderings can also be formed on different components. These solderings can be formed simultaneously during the first process step as a result of dividing the beam into the plurality of partial light beams 12a-12c. Subsequently, the adjustment device 15 is driven and an adjacent set of components having the same geometric configuration or being disposed in the same geometric configuration are transferred into the work area of the imaging optics 1 and of the DOE 5 such, that the partial light beams 12a-12c are imaged onto the corresponding solderings in the same manner as during the first process step, e.g. onto the contact pins 14a′, 14b′ and 14c′ shown. This together forms the second process step, which can be repeated in a corresponding manner. Between the individual process steps the substrate is moved each time by the same distance, which is determined by the distance between the individual periodic configurations of the components on the substrate.

For controlling the laser soldering apparatus according to FIG. 1, a control device is provided, e.g. a CPU (not shown), which controls particularly the adjustment device 4, the changing device 7, the translational device 15 with the associated drive 16 and the laser diode 8.

Further details of the imaging optics 1 can be derived from FIG. 2. Between the lenses 2, 3, which are disposed along the optical axis 11 and spaced apart to each other, a DOE 5 is disposed which divides the input light beam 10 into the shown partial light beams 12a-12c by diffraction. As a result of the imaging characteristics of lenses 2, 3 and/or of DOE 5 the partial light beams 12a-12c are focused or imaged in a suitable manner. Caused by a different diffraction in sub-zones 6a-6c of the DOE 5, the partial light beams 12a-12c are deflected into suitable directions. According to FIG. 2 a plurality of different diffractive optical zones 6a-6c can be provided on DOE 5, which impose a different intensity, beam cross section, beam profile or beam shape and/or divergence on the partial light beams 12a-12c. The person skilled in the art easily will be capable of selecting a suitable configuration of DOE 5 and of diffractive optical zones 6a-6c. As will become apparent to the person skilled in the art, a great many of partial light beams 12a-12c can be formed simultaneously by suitably expanding the input light beam 10 and by suitable configuration of the diffractive optical zones 6a-6c.

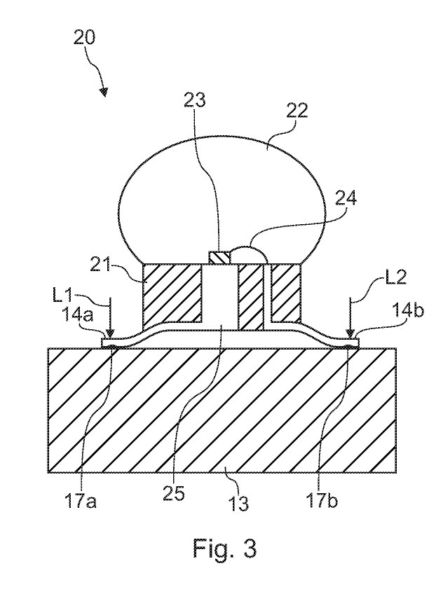

FIG. 3 schematically shows a process according to the invention for laser soldering of an LED 20. LED 20 comprises a socket 21 on which a light emitter 23 is disposed, which is contacted via a bonding wire 24. Furthermore, on socket 21 an optical lens element 22 is provided for beam shaping of the emitted light beam. The light emitter 23 is disposed on a heat sink 25, having a high thermal conductivity in order to minimize the thermal load of the light emitter 23. According to FIG. 3, contact pins 14a, 14b are fed through socket 21 for electrically contacting the p-side and n-side of light emitter 23. LED 20 is disposed on a printed circuit board 13. As shown in FIG. 3 and described above with reference to FIG. 1 and 2, a laser beam is divided into two partial light beams L1, L2 and imaged onto contact pins 14a, 14b by means of an imaging optics so that soft solder can be molten in these areas and so that the solderings 17a, 17b as shown, can be formed in accordance with the geometric configuration of contact pins 14a and 14b. Of course, in this manner plural LEDs can be soldered simultaneously using a single process step.

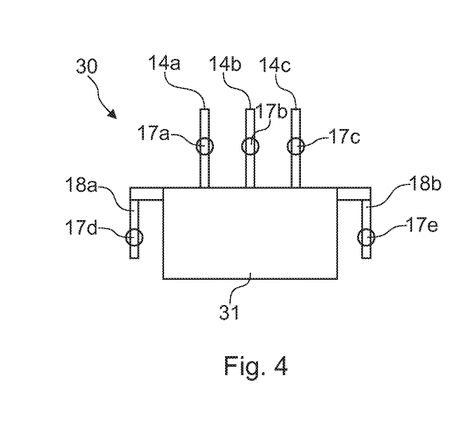

The process according to the present invention is also suited for contacting connectors, micro-electromechanical elements and the like, as set forth with reference to FIG. 4. According to FIG. 4 connector 30, which is shown in a plan view, comprises three contact pins 14a-14c and two tongues 18a, 18b for effecting a pull relief, which are contacted or connected by means of the soldering 17a-17e shown. In order to connect the pull relief tongues 18a, 18b, a higher laser power might be necessary. This is accomplished by a suitable beam dividing using DOE of the imaging optics. Upon dividing the input light beam, generally arbitrary beam division ratios can be accomplished. Also in the embodiment according to FIG. 3, the contacting or fixing of heat sink 25 might require a higher laser power or laser intensity.

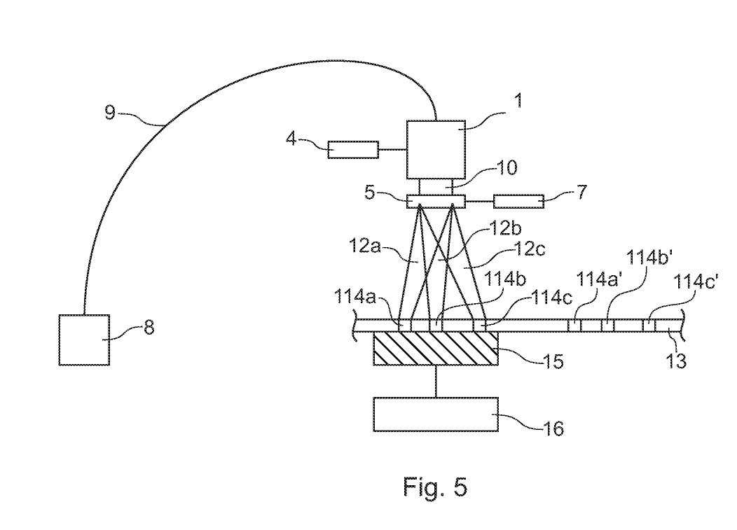

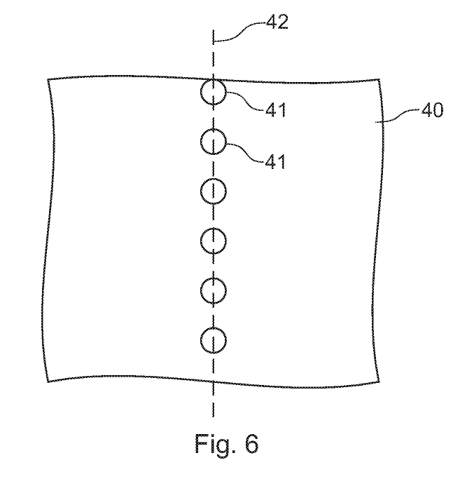

With reference to FIGS. 5 and 6 in the following an apparatus and process for simultaneously forming a plurality of preweakened zones or perforations within a substrate will be described.

According to FIG. 5, a plurality of light spots are formed on the substrate 13, e.g. in a periodic configuration of which only respective three light spots for forming preweakened material zones or perforations 114a, 114b, 114c are shown. The light spots on the substrate 13 are formed in a suitable geometric configuration, as requested e.g. by the normal use of the substrate. The geometric configuration of the light spots can be essentially arbitrary in the plane of substrate 13. In order to accomplish a suitable imaging and deflection of the partial light beams 12a-12c only the imaging optics 1 and the diffractive optical element 5 need to be configured suitably, in a manner essentially identical to that set-forth above with regard to laser soldering. For this purpose a diffractive imaging optics may be used, as set forth above in more detail with regard to laser soldering.

The process according to the present invention for forming a plurality of preweakened material zones or perforations in a substrate is essentially identical to that set-forth above with regard to laser soldering, the main difference being that the light spots cause simultaneous formation of a plurality of discrete preweakened material zones or perforations in a substrate instead of a plurality of discrete solderings.

Generally, the process according to the above related aspect of the present invention is also suitable for processing substrates by simultaneously processing a substrate at a plurality of locations. For this purpose, an input light beam is divided in the aforementioned manner into a plurality of partial light beams, which form a plurality of discrete processing locations 41 on work piece 40, as shown in FIG. 6, e.g. holes, blind holes and/or weakening portions. The process is suitable for processing arbitrary substrates, e.g. paper or cardboard, plastics materials or metal sheets. The plurality of processing locations 41 can be disposed along an arbitrary line 42 as shown in FIG. 6 and may form e.g. a line of predetermined breaking points in plastics covers of airbag modules of motor vehicles or in containers of paper or cardboard, as described in more detail e.g. in EP 0 566 722 B1.

The process according to the above related aspect of the invention can be claimed as follows:
A process for forming a plurality of preweakened zones or perforations in a substrate, comprising the steps of:
   providing a light beam;
   imaging said light beam using imaging optics and dividing said light beam into a plurality of partial light beams using light diffraction such that a plurality of discrete light spots are formed on said substrate, said discrete light spots simultaneously forming a plurality of discrete preweakened material zones or perforations within said substrate.

According to another embodiment according to the above aspect said light spots form one of: holes, blind holes and weakening portions.

According to another embodiment according to the above aspect said imaging optics comprises a diffractive element, which divides said light beam into said plurality of partial light beams by diffraction.

Thus, according to another related aspect of the present invention, there is also provided a process for processing substrates, in which method a light beam, in particular a laser light beam, is provided, an imaging optics images the light beam and divides the light beam into a plurality of partial light beams such that a plurality of discrete light spots are formed which accomplish processing of the respective substrate.

As will become apparent to a person skilled in the art when studying the present application, the discrete connecting or processing locations can also overlap partially with each other. The partial light beams can be directed in an arbitrary manner onto the joining or processing locations on the front side and/or rear side of a carrier or substrate. For this purpose, holes can also be provided in the carrier or substrate or the carrier might be transparent at least in portions in order to enable an optical access to the joining or processing locations. As regards further details of laser soldering of opto-electronic components, e.g. high power LEDs or high power laser diodes, reference is made to US 2004/0190294 A1 the whole content of which is hereby incorporated by reference, in particular with regard to the configuration of a printed circuit board (PCB) for contacting elements or components.

### List of Reference Numerals

1 Imaging optics
2 Input lens
3 Output lens
4 Adjustment device
5 Diffractive optical element
6a-6c Diffractive optical elements/diffractive optical zones
7 Changing (replacement) device
8 Light source (laser diode, LED)
9 Light-waveguide
10 Input light beam
11 Optical axis
12a-12c Partial light beams
13 Printed circuit board
14a-14c Contact pins
14a′-14c′ Contact pins formed during next process step
114a-114c preweakened zones or perforations
114a′-114c′ preweakened zones or perforations formed during next process step
15 Translational device
16 Drive
17a-17e Solderings
18a-18d Pull relief tongues
20 LED
21 Socket
22 Lens
23 Semiconductor component/Light emitter
24 Bonding wire
25 Heat sink
30 Connector
31 Socket
40 Work piece
41 Perforation/weakening area
42 Line

What is claimed is:

1. A process for joining at least two elements, comprising the steps of:
providing a light beam;
imaging said light beam using imaging optics and dividing said light beam into a plurality of partial light beams such that a plurality of discrete light spots are formed for forming a plurality of discrete material joining portions between said at least two elements.

2. The process as claimed in claim 1, wherein said imaging optics comprises a diffractive optical element which divides said light beam into said plurality of partial light beams by diffraction.

3. The process as claimed in claim 2, wherein the joining portions are formed in a predetermined configuration, which is given by the configuration of the elements to be joined and/or by the geometric configuration thereof, and wherein the diffractive optical element divides said input light beam into said partial light beams in accordance with said predetermined configuration of joining portions and directs the same into different directions.

4. The process as claimed in claim 3, wherein the diffractive optical element comprises a plurality of diffractive optical zones in accordance with said predetermined configuration of joining portions.

5. The process as claimed in claim 4, wherein the diffractive optical zones cause at least one of: different intensities, different beam cross sections, different beam shapes and beam divergence of said partial light beams.

6. The process as claimed in claim 2, wherein said light beam is emitted from a light waveguide and said imaging optics comprises an input lens and an output lens, wherein a beam diameter of said light beam or of said partial light beams is adjusted by varying at least one of: the distance between the input lens and the light waveguide and the distance between the input lens and the output lens.

7. The process as claimed in claim 6, wherein the diffractive optical element is disposed between the input lens and the output lens.

8. The process as claimed in claim 1, wherein the material joining portions are formed by one of: soft-soldering, soldering, welding and photo curing of an adhesive.

9. The process as claimed in claim 1, wherein the joining portions are formed on contact pins of at least one electronic or opto-electronic component or of at least one connector by melting of a solder for joining the same with a carrier.

10. The process as claimed in claim 9, wherein said carrier is a printed circuit board (PCB).

11. The process as claimed in claim 1, wherein said light beam is a laser light beam.

12. The process as claimed in claim 1, wherein said elements comprise at least one of: electronic components, microelectronic components, opto-electronic components, optical components, MEMS.

13. An apparatus for joining at least two elements, comprising:
holding means for positioning said elements or a substrate;
light source means for providing a light beam; and
imaging means for imaging said light beam and dividing said light beam into a plurality of partial light beams such that a plurality of discrete light spots are formed which cause a joining between said at least two elements at a plurality of discrete material joining portions.

14. The apparatus as claimed in claim 13, wherein said imaging means comprises a diffractive optical element, which divides said light beam into said plurality of partial light beams by diffraction.

15. The apparatus as claimed in claim 14, wherein said holding means positions said elements in a pre-determined configuration and said diffractive optical element divides said light beam into said partial light beams in accordance with said predetermined configuration and directs the same into different directions.

16. The apparatus as claimed in claim 15, wherein said diffractive optical element comprises a plurality of diffractive optical zones in accordance with said pre-determined configuration of joining portions.

17. The apparatus as claimed in claim 16, wherein said diffractive optical zones cause at least one of: different intensities, different beam cross sections, different beam shapes and different beam divergence of said partial light beams.

18. The apparatus as claimed in claim 13, further comprising a light waveguide, wherein said imaging optics comprises an input lens and an output lens so that a beam diameter of said light beam are of said partial light beams is adjusted by varying at least one of: a distance between said input lens and said light waveguide and a distance between said input lens and said output lens.

19. The apparatus as claimed in claim 18, wherein said diffractive optical element is disposed between said input lens and said output lens.

20. The apparatus as claimed in claim 13, wherein said light source means is configured for providing at least one laser light beam.
